(19) United States
(12) Patent Application Publication
(10) Pub. No.: US 2009/0328004 A1
(43) Pub. Date: Dec. 31, 2009

(54) METHOD TO COLLABORATIVELY RESOLVE JAVA PROGRAM ERRORS WITHIN AN INTEGRATED DEVELOPMENT ENVIRONMENT

(75) Inventor: Swaminathan Balasubramanian, Sterling Heights, MI (US)

Correspondence Address: IBM CORPORATION (ACCSP);c/o Suiter Swantz pc llo, 14301 FNB Parkway, Suite 220, Omaha, NE, 68154, US

(73) Assignee: International Business Machines Corporation, Armonk, NY (US)

(21) Appl. No.: 12/163,270

(22) Filed: Jun. 27, 2008

(51) Int. Cl. G06F 11/36

(52) U.S. Cl. 717/125

(57) ABSTRACT

The present disclosure is directed to a method to collaboratively resolve a Java program error. The context of the access is uniquely identified based on two parameters—the error and the specific library where the error occurred. The developer uses the same interface to contribute to discussions irrespective of the error or the library. The method automatically determines the forum for the discussion. Finally, the method is able to notify the developer when the error is resolved so that the developer can contribute resolution information back to the discussion.

### TECHNICAL FIELD

The present disclosure generally relates to the field of computer programming, and more particularly to a method for resolving a Java program error in an Integrated Development Environment.

### BACKGROUND

Java programs under development are routinely executed within the Integrated Development Environment (IDE) in a controlled debug mode. The application developer is able to step through the executing code and watch for error conditions. When an error occurs, the debugger pauses or aborts the execution of the program and directs the stack trace to the console. The application developer needs to use the stack trace to determine the root cause of the error.

Most Java programs rely on functionality provided by third party libraries. It is common practice to use large numbers of such libraries within the program. When an error occurs, the developer needs to identify the library where the error occurred and perform an analysis.

Most automated assistance systems rely on an underlying knowledgebase and are effective only when the knowledgebase grows beyond a critical size. With large numbers of libraries becoming available constantly, especially in the open source community, the time needed to build an effective knowledgebase becomes too large. Further, the developer has no ability to contribute and grow the knowledgebase.

Predictive methods are unable to assist in root cause analysis. Preventive methods are able to spot syntactic errors, but cannot spot runtime errors that result during execution. Oftentimes, library providers supply documentation that can aid analysis. However, this is of limited help because providers are not able to anticipate all the scenarios in which their libraries may be used.

Collaborative error resolution through the use of discussion forums has become very popular with Web 2.0. Many forums are available where the developer can enter into discussions with their peers to resolve errors. However, these forums are dispersed and are not organized by libraries or by error conditions. In other words, these forums are not organized contextual to the error. Hence resolving errors in this manner is inefficient and time consuming.

### SUMMARY

The present disclosure is directed to a method to collaboratively resolve a Java program error. The context of the access is uniquely identified based on two parameters—the error and the specific library where the error occurred. The developer may use the same interface to contribute to discussions irrespective of the error or the library. The method automatically determines the forum for the discussion. Finally, the method is able to notify the developer when the error is resolved so that the developer can contribute resolution information back to the discussion.

With this method, there are several advantages over existing approaches:
A pre-existing knowledgebase is not necessary to enter into discussions.
Discussions are organized by errors and libraries; hence, the developer is not required to have prior knowledge about forum locations.
By using a uniform interface across forums, the developer always works with a familiar interface. This feature enhances productivity.
The IDE automatically notifies the developer when an error is resolved; thus, giving the developer an opportunity to grow the knowledgebase.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram of a method to collaboratively resolve Java program errors.

### DETAILED DESCRIPTION

Reference will now be made in detail to the subject matter disclosed, which is illustrated in the accompanying drawings.

The present disclosure is directed to a method to collaboratively resolve Java program errors. The method may utilize two distinct identifications, the error and the specific library where the error occurred, to determine an appropriate forum for the user to research the Java program error. The method also gives the user an ability to contribute to discussion boards, irrespective of the user's current error. Finally, the method may notify the user when the error is resolved.

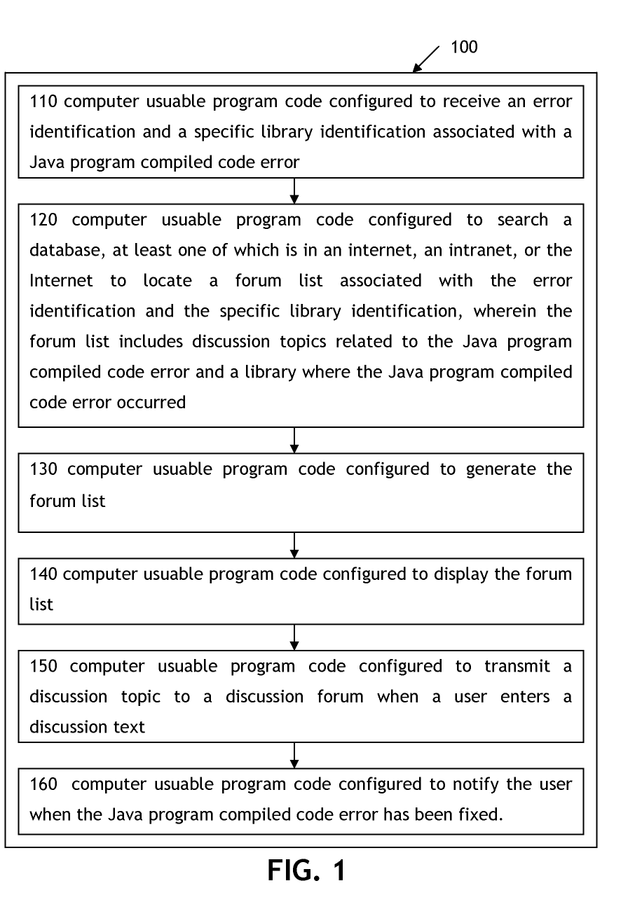

Referring to FIG. 1, the present disclosure is illustrated. Upon the initiation of the method to collaboratively resolve Java program errors 100, the method receives an error identification and a specific library identification associated with a Java program compiled code error 110. Once the error identification and the specific library identification are received 110, the method 100 then searches a database, at least one of which is in an internet, an intranet, or the Internet to locate a forum list associated with the error identification and the specific library identification, wherein the forum list includes discussion topics related to the Java program compiled code error and a library where the Java program compiled code error occurred 120. Upon the completion of the search of the databases 120, the method 100 generates the forum list 130. Then, the forum list is displayed 140. The method 100 transmits a discussion topic to a discussion forum when a user enters a discussion text 150. Finally, the method 100 notifies the user when the Java program compiled error has been fixed.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A computer program product for collaboratively resolving object oriented programming code program errors, a computer program product comprising:
a tangible computer usable medium having computer usable code tangibly embodied therewith, the computer usable program code comprising:
computer usable program code configured to receive an error identification and a specific library identification associated with an object oriented programming code program compiled code error;
computer usable program code configured to search a database, at least one of which is in an internet, an intranet, or the Internet to locate a forum list associated with the error identification and the specific library identification, wherein the forum list includes discussion topics, the discussion topics organized by errors and libraries, related to the object oriented programming code program compiled code error and a library where the object oriented programming code program compiled code error occurred;
computer usable program code configured to generate the forum list;
computer usable program code configured to display the forum list;
computer usable program code configured to transmit a discussion topic to a discussion forum when a user enters a discussion text; and
computer usable program code configured to notify the user when the object oriented programming code program compiled code error has been fixed.
